(19) United States
(12) Patent Application Publication
(10) Pub. No.: US 2026/0341591 A1
(43) Pub. Date: Oct. 29, 2026

(54) IGNITION COIL

(71) Applicant: DIAMOND&ZEBRA ELECTRIC MFG. CO., LTD., Osaka (JP)

(72) Inventors: Daiki YOSHIHARA, Osaka-shi (JP); Takushi NISHIMURA, Osaka-shi (JP)

(73) Assignee: DIAMOND&ZEBRA ELECTRIC MFG. CO., LTD., Osaka (JP)

(21) Appl. No.: 19/654,901

(22) Filed: Apr. 22, 2026

(30) Foreign Application Priority Data
Apr. 23, 2025 (JP) 2025-071578

(51) Int. Cl. H01F 38/12; H01F 27/29; H01F 41/04

(52) U.S. Cl. CPC H01F 38/12; H01F 27/29; H01F 41/04

(57) ABSTRACT

An ignition coil 2 according to one embodiment includes: a coil assembly 8 including a primary coil and a secondary coil 34; a case 4 enclosing the coil assembly 8; a diode support 12 having a shape of a flat plate, the diode support 12 being located below the coil assembly 8 and mounted on the bottom of the case 4; one or more diodes 14 fixed to the diode support 12; and an output terminal. An output from the coil assembly 8 is output to the output terminal through the diodes 14.

### CROSS-REFERENCE TO RELATED APPLICATION

This application claims priority to and the benefit of Patent Application No. 2025-071578 filed in JAPAN on Apr. 23, 2025. The entire disclosure of this Japanese Application is hereby incorporated by reference.

### BACKGROUND OF THE INVENTION

### Field of the Invention

The present specification relates to ignition coils.

### DESCRIPTION OF THE RELATED ART

In general, an ignition coil for an internal combustion engine includes an iron core, a primary coil, and a secondary coil as internal components (which are collectively referred to herein as a “coil set”). In this ignition coil, a current flowing through the primary coil is controlled to generate a strong induced electromotive force in the secondary coil. The induced electromotive force is applied to an ignition plug to ignite fuel.

In some types of ignition coils, a diode is disposed subsequent to the output of a coil set in order to prevent a current from flowing back through the coil set and causing damage to the coil set. In particular, in a “dual-coil” ignition coil including two internal coil sets, such a diode for reverse-current prevention plays an important role in preventing an output current from one of the coil sets from flowing into the other coil set. Japanese Laid-Open Patent Application Publication No. 2013-243239 reports a dual-coil ignition coil including a diode for reverse-current prevention.

Since coil sets generate high voltages, a plurality of diodes for reverse-current prevention are often required for each coil set. For example, diodes available at ordinary cost have a withstand voltage ranging from 1 to 17.5 kV, and at least three such diodes are needed to ensure that the coils can generate a maximum voltage (for example, 50 kV). In the production of an ignition coil, it is necessary to arrange these diodes while maintaining an insulating distance between the diodes and coil sets, and connect the arranged diodes to the coil sets and the output terminal of the ignition coil. This process is cumbersome, and inaccurate mounting of the diodes might cause insulation failure. There is a demand for an ignition coil that can be assembled efficiently and with high precision.

The present inventors aim to provide an ignition coil that can be assembled efficiently and with high precision.

### SUMMARY OF THE INVENTION

An ignition coil according to one embodiment includes: a coil assembly including a primary coil and a secondary coil; a case enclosing the coil assembly; a diode support having a shape of a flat plate, the diode support being located below the coil assembly and mounted on a bottom of the case; one or more diodes fixed to the diode support; and an output terminal. An output from the coil assembly is output to the output terminal through the diodes.

In the ignition coil of the present embodiment, the diodes are fixed to the diode support having the shape of a flat plate, and the diode support is located below the coil assembly and mounted on the bottom of the case. In this ignition coil, the arrangement of the diodes and the connection of the diodes with the coil assembly can be achieved simply by mounting the diode support with the diodes to the bottom of the case and placing the coil assembly into the case. This ignition coil can be assembled efficiently. In addition, in this ignition coil, an insulating distance between the diodes and the coil assembly can be ensured with high precision by maintaining a distance equal to or greater than a predetermined value between the diode support and the coil assembly. Furthermore, by virtue of having the shape of a flat plate, the diode support is easily mountable to the bottoms of cases of varying sizes. The sizes of coil assemblies and cases of ignition coils widely vary depending on the types of the ignition coils. In the case of ignition coils having the structure according to the present embodiment, mounting of diodes for reverse-current prevention can be accomplished easily and with high assembly precision while being little affected by variations in the sizes of coil assemblies and cases.

### BRIEF DESCRIPTION OF THE DRAWINGS

FIG. 1 is a perspective view showing an ignition coil according to one embodiment.

FIG. 2 is a cross-sectional view taken along the line II-II of FIG. 1.

FIG. 3 is an exploded perspective view of the ignition coil of FIG. 1.

FIG. 4A is an enlarged perspective view showing the diode support of FIG. 2 with diodes mounted thereon, and FIG. 4B is a bottom view of the diode support of FIG. 4A.

FIG. 5 is a bottom of the diode support of FIG. 2.

FIG. 6 is a plan view showing the connection between a terminal pattern of the diode support of FIG. 2 and diodes.

FIG. 7 is a plan view of a case with the diode support mounted thereon.

FIG. 8 is a cross-sectional perspective view taken along the line VIII-VIII of FIG. 7.

FIG. 9 is a side view showing a resistor, a diode support, and a coil assembly of the ignition coil of FIG. 1.

FIG. 10 is a circuit diagram of the ignition coil of FIG. 1.

### DETAILED DESCRIPTION

The following will describe preferred embodiments in detail with appropriate reference to the drawings.

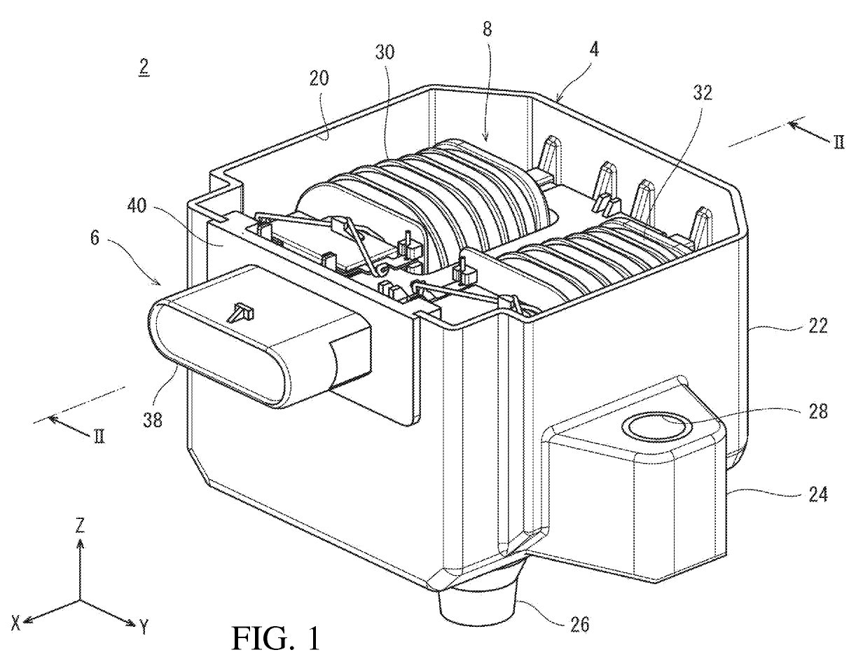

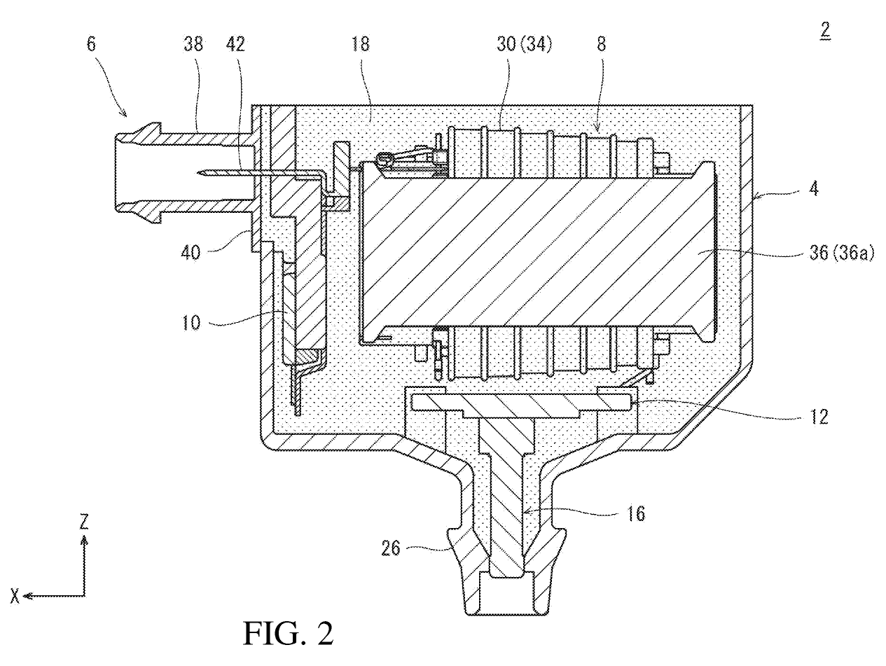

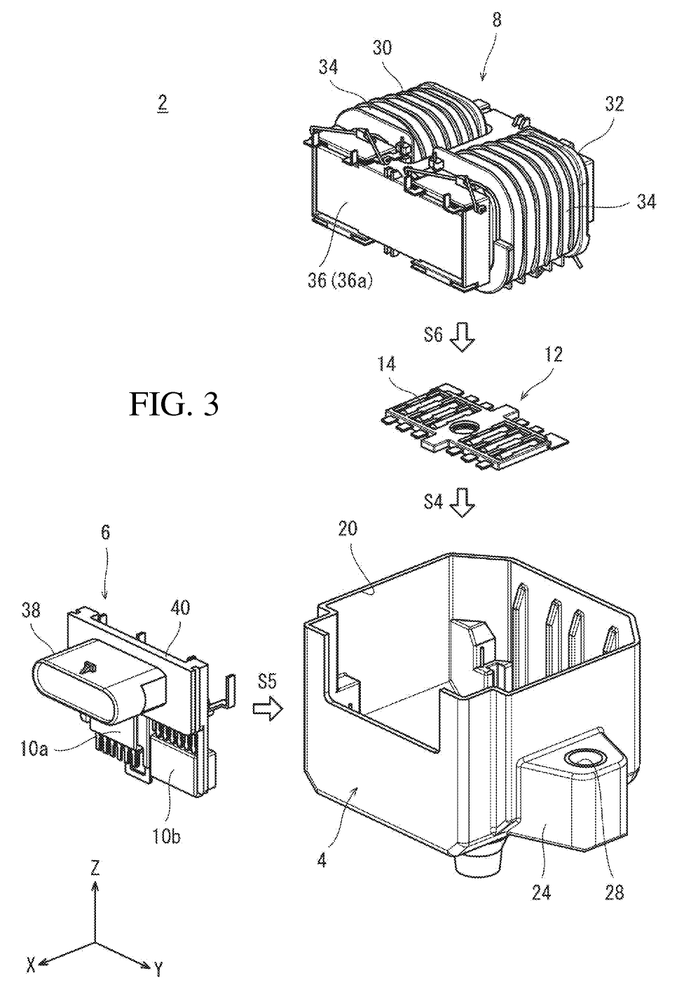

FIG. 1 is a perspective view showing an ignition coil 2 according to one embodiment. FIG. 2 is a cross-sectional view taken along the line II-II of FIG. 1. FIG. 3 is an exploded view of the ignition coil 2 of FIG. 1. In FIGS. 1 through 3, the arrow X represents the forward direction with respect to the ignition coil 2. The opposite direction is the backward direction. The arrow Y represents the rightward direction with respect to the ignition coil 2. The opposite direction is the leftward direction. The arrow Z represents the upward direction with respect to the ignition coil 2. The opposite direction is the downward direction. In this embodiment, the ignition coil 2 is intended for use in an engine that uses a flame-retardant fuel such as ammonia. As shown in FIG. 1, the ignition coil 2 includes a case 4, a connector portion 6, and a coil assembly 8. As shown in FIGS. 2 and 3, the ignition coil 2 further includes igniters 10, a diode support 12, diodes 14, a resistor 16, and a filler 18. In FIGS. 1 and 3, the filler 18 is omitted.

As shown in FIG. 3, the case 4 has the shape of a box with a hollow interior. In this embodiment, the case 4 includes an opening 20 extending over the entire top surface and a part of the front surface (the surface on which the connector portion 6 is located). The case 4 is made of a resin composition. Preferred examples of materials for the case 4 include PBT (polybutylene terephthalate), PPS (polyphenylene sulfide), and PET (polyethylene terephthalate).

As shown in FIGS. 2 and 3, the case 4 includes a main body 22, a flange portion 24 extending rightward from the right surface of the main body 22, and an output tower 26 extending downward from the bottom surface of the main body 22. Although not shown in FIG. 3, the case 4 further includes a flange portion 24 extending leftward from the left surface of the main body 22. Each flange portion 24 includes a hole 28 extending from the top to the bottom of the flange portion 24. Although not shown, a bolt is inserted into the hole 28 and a hole in the engine to secure the ignition coil 2 to the engine. As shown in FIG. 2, the output tower 26 is tubular. In this embodiment, the main body 22, the flange portions 24, and the output tower 26 are formed integrally. The output tower 26 may be formed separately from the main body 22 and attached to the main body 22.

As shown in FIGS. 1 and 2, the coil assembly 8 is enclosed within the case 4. In FIG. 2, for ease of understanding, portions of the coil assembly 8 that are covered by the filler 18 are shown with hatching representing the filler 18. In this embodiment, as shown in FIGS. 1 and 3, the coil assembly 8 includes a first coil set 30 and a second coil set 32. The coil assembly 8 is a dual coil.

Each coil set includes a primary coil (not shown), a secondary coil 34, and an iron core 36. The iron core 36 includes a central iron core (not shown) and an outer iron core 36a. The central iron core extends through the centers of the primary coil and the secondary coil 34 in the forward/rearward direction. The outer iron core 36a extends from one end of the central iron core, passes outside the side surfaces of the primary coil and the secondary coil 34, and reaches the other end of the central iron core. In this embodiment, the outer iron core 36a of the first coil set 30 and the outer iron core 36a of the second coil set 32 share a common portion located at the center of the coil assembly 8 and extending in the forward/backward direction.

In each coil set, the number of wire turns in the secondary coil 34 is significantly greater than the number of wire turns in the primary coil. Accordingly, changing the current through the primary coil generates a high voltage in the secondary coil 34. The output of the secondary coil 34 corresponds to the output of the coil assembly 8. In the coil assembly 8, there are a first coil output terminal connected to the secondary coil 34 of the first coil set 30 and a second coil output terminal connected to the secondary coil 34 of the second coil set 32, although these output terminals are not shown. The wire of each primary coil and the wire of each secondary coil 34 are typically copper wires.

The connector portion 6 is located at the front of the case 4. The connector portion 6 receives a signal input from an external source. The connector portion 6 includes a tubular portion 38, a base portion 40, and connector terminals 42. The tubular portion 38 has the shape of a tube with a front opening. The connector terminals 42 are located within the tubular portion 38. There are a plurality of connector terminals 42. In this embodiment, the connector terminals 42 include a first control terminal for the first coil set 30, a second control terminal for the second coil set 32, a power supply terminal, and a ground terminal. The base portion 40 has the shape of a plate. In this embodiment, the based portion 40 covers that portion of the opening 20 of the case 4 which is located on the front surface of the case 4.

As shown in FIG. 2, the igniters 10 are enclosed within the case 4. In this embodiment, as shown in FIG. 3, there are a first igniter 10a for the first coil set 30 and a second igniter 10b for the second coil set 32. Each igniter 10 is located between the coil assembly 8 and the connector portion 6. The first igniter 10a receives a control signal input from an external source through the first control terminal, and the second igniter 10b receives a control signal input from an external source through the second control terminal. In response to the control signal, each igniter 10 switches between permitting and blocking current flow through the primary coil of the corresponding coil set.

In this embodiment, as shown in FIG. 2, the resistor 16 is located within the output tower 26. In this embodiment, the lower end of the resistor 16 serves as an outlet for output signals from the ignition coil 2. In other words, in this embodiment, the lower end of the resistor 16 functions as an output terminal of the ignition coil 2. When the ignition coil 2 is mounted to an internal combustion engine, the output terminal is electrically connected to an ignition plug.

In another embodiment, the output terminal is not necessarily the lower end of the resistor 16. For example, in an embodiment in which the ignition coil 2 includes a spring extending downward from the lower end of the resistor 16, the lower end of the spring serves as the output terminal. In any case, the resistor 16 is electrically connected to the output terminal.

As shown in FIG. 2, the diode support 12 is located between the bottom surface of the case 4 and the coil assembly 8. The diode support 12 is located below the coil assembly 8 and mounted on the bottom of the case 4. The diode support 12 has the shape of a flat plate. As shown in FIG. 3, the diodes 14 are mounted on the diode support 12. In this embodiment, six diodes 14 are fixed to the diode support 12.

The filler 18 fills gaps present inside the case 4. The filler 18 is formed by hardening a fluid filling material. In this embodiment, the filler 18 is made of a thermosetting resin. The filler 18 insulates the secondary coils 34, which generate high voltages, from the other components. For this reason, a thermosetting resin with high insulation performance is selected as the material of the filler 18. To thoroughly fill the gaps present inside the case 4, a thermosetting resin that has not yet hardened and has low viscosity is selected as the material of the filler 18. Preferred examples of the filler 18 are epoxy resins.

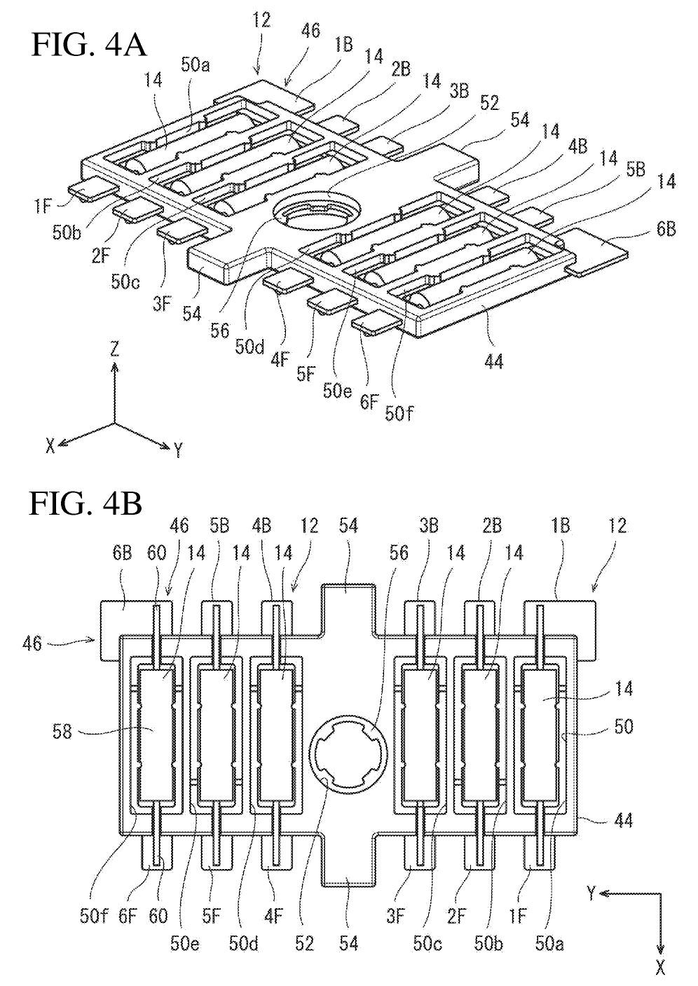

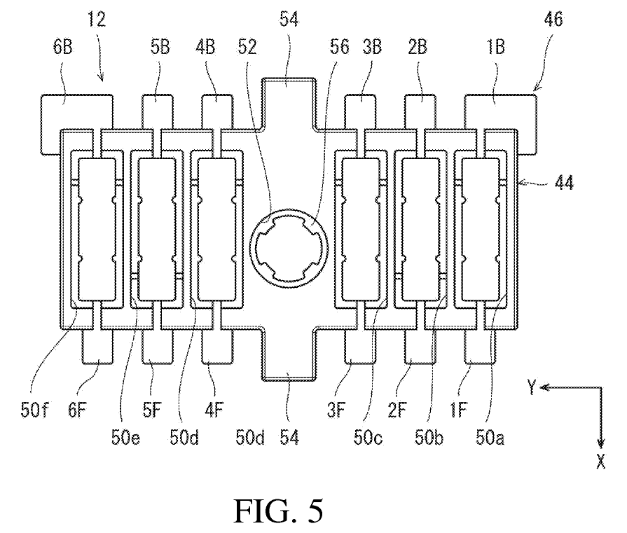

FIG. 4A is an enlarged perspective view showing the diodes 14 and the diode support 12 of FIGS. 3, and 4B, is a bottom view of the diodes 14 and the diode support 12. FIG. 5 is a bottom view showing the diode support 12 without the diodes 14 mounted thereon. The diode support 12 includes a frame 44 and a terminal pattern 46.

The frame 44 includes mounting portions 50 to which the diodes 14 are mounted. In this embodiment, the mounting portions 50 are holes. In this embodiment, the mounting portions 50 of the frame 44 are six mounting holes 50 each of which has a rectangular opening. The mounting holes 50 are referred to as first to sixth mounting holes 50a to 50f in order from left to right in FIG. 4A (from right to left in FIG. 4B). Around the center of the frame 44, there is a hole 52 having a circular opening. As described later, an upper end portion of the resistor 16 is inserted into the circular hole 52, which serves as an outlet for signals input to the diodes 14; accordingly, this circular hole is referred to herein as an outlet hole 52. In this embodiment, the first mounting hole 50a, the second mounting hole 50b, and the third mounting hole 50c are located to the left of the outlet hole 52, and the fourth mounting hole 50d, the fifth mounting hole 50e, and the sixth mounting hole 50f are located to the right of the outlet hole 52.

The frame 44 further includes a pair of positioning protrusions 54. One of the positioning protrusions 54 protrudes forward from the front surface of the frame 44, and the other positioning protrusion 54 protrudes from the back surface of the frame 44. The frame 44 is electrically insulating. In this embodiment, the frame 44 is made of a resin composition. Preferred examples of materials for the frame 44 include PBT, PPS, PET, and PPE (polyphenylene ether).

A part of the terminal pattern 46 is embedded in the frame 44, and the rest of the terminal pattern 46 is exposed outside the frame 44. In this embodiment, the terminal pattern 46 includes terminal blocks that protrude from the frame 44 and each of which is located in front of or behind a corresponding one of the first to sixth mounting holes 50a to 50f. A terminal block located behind the first mounting hole 50a is referred to as a terminal block 1B, and a terminal block located in front of the first mounting hole 50a is referred to as a terminal block 1F. Likewise, in this embodiment, there are a terminal block 2B, a terminal block 2F, a terminal block 3B, a terminal block 3F, a terminal block 4B, a terminal block 4F, a terminal block 5B, a terminal block 5F, a terminal block 6B, and a terminal block 6F. As shown in FIG. 4B, the terminal blocks 1B and 6B have a larger surface area than the other terminal blocks. As described later, these two terminal blocks serve as inlets for signals input to the diodes 14; accordingly, these blocks are referred to as inlet terminal blocks 1B and 6B. As shown in FIG. 4B, the terminal pattern 46 further includes an annular outlet projecting portion 56 projecting inward from the inner circumferential surface of the outlet hole 52.

The terminal pattern 46 is electrically conductive. Typically, the terminal pattern 46 is made of a metal. Preferred examples of materials for the terminal pattern 46 include copper, aluminum alloys, brass, and iron.

Each diode 14 includes a main body 58 and a pair of terminal wires 60. As seen from comparison of FIGS. 4B and 5 , the main body 58 of each diode 14 is located within a corresponding one of the mounting holes 50. Each of the terminal wires 60 of the diodes 14 is in contact with a corresponding one of the terminal blocks 1B to 6F. For example, one of the terminal wires 60 of the diode 14 with its main body 58 located within the first mounting hole 50a is in contact with the terminal block 1B, and the other terminal wire 60 is in contact with the terminal block 1F. Each terminal wire 60 is in contact with the lower surface of the corresponding terminal block (the surface facing away from the coil assembly 8 and facing toward the bottom of the case 4). The terminal blocks 1B to 6F and the terminal wires 60 are soldered or welded together. Thus, the diodes 14 are electrically connected to the terminal pattern 46.

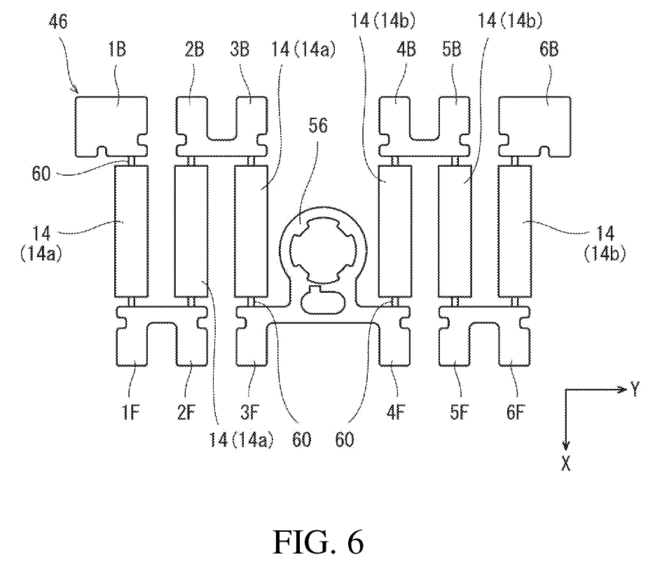

FIG. 6 is a plan view showing the diode support 12 with the diodes 14 mounted and the frame 44 removed. It should be noted that FIG. 6 shows the diode support 12 as viewed in a direction different from that in which the diode support 12 is seen in FIG. 5. In FIG. 6, the connection between the diodes 14 and the terminal pattern 46 is shown, including the part of the terminal pattern 46 that is embedded in the frame 44.

As shown in FIG. 6, the terminal blocks 1F and 2F are connected to each other, the terminal blocks 2B and 3B are connected to each other, and the terminal block 3F is connected to the inwardly projecting portion. Thus, the three diodes 14 on the left side are connected in series. The three diodes 14 connected in series are collectively referred to as a first diode set 14a. The terminal wires 60 of the rightmost diode 14 of the first diode set 14a are electrically connected to the outlet projecting portion 56 via the terminal block 3F. The inlet terminal block 1B, the first diode set 14a, and the outlet projecting portion 56 are connected in series in this order. As described later, a high voltage from the first coil set 30 is input to the inlet terminal block 1B. Each diode 14 of the first diode set 14a is forward-biased with respect to the high voltage applied from the first coil set 30.

As shown in FIG. 6, the terminal blocks 6F and 5F are connected to each other, the terminal blocks 5B and 4B are connected to each other, and the terminal block 4F is connected to the outlet projecting portion 56. Thus, the three diodes 14 on the right side are connected in series. The three diodes 14 connected in series are collectively referred to as a second diode set 14b. The terminal wires 60 of the leftmost diode 14 of the second diode set 14b are electrically connected to the outlet projecting portion 56 via the terminal block 4F. The inlet terminal block 6B, the second diode set 14b, and the outlet projecting portion 56 are connected in series in this order. As described later, a high voltage from the second coil set 32 is input to the inlet terminal block 6B. Each diode 14 of the second diode set 14b is forward-biased with respect to the high voltage applied from the second coil set 32.

The number of diodes 14 in the first diode set 14a or the second diode set 14b is not limited to three. Each diode set 14a or 14b may include two diodes 14, a single diode 14, or four or more diodes 14. When each of the first and second diode sets 14a and 14b includes two diodes 14 or a single diode 14, the number of the mounting portions 50 of the frame 44 and the number of the terminal blocks correspondingly decrease. When each of the first and second diode sets 14a and 14b includes four or more diodes 14, the number of the mounting portions 50 of the frame 44 and the number of the terminal blocks in the diode support 12 correspondingly increase.

In this embodiment, the ignition coil 2 is produced through the following steps of:
(S1) preparing the diode support 12;
(S2) mounting the diodes 14 to the diode support 12;
(S3) mounting the resistor 16 to the case 4;
(S4) mounting the diode support 12 to the case 4;
(S5) mounting the connector portion 6 to the case 4;
(S6) placing the coil assembly 8 into the case 4; and
(S7) forming the filler 18 in the case 4.

In step S1, the diode support 12 shown in FIG. 5 is prepared. In this embodiment, the frame 44 is formed around the fixed terminal pattern 46 by injection molding. As a result, the diode support 12 having the terminal pattern 46 partially embedded in the frame 44 is formed.

In step S2, the diodes 14 are mounted to the diode support 12. As shown in FIG. 4B, the main bodies 58 of the diodes 14 are fitted into the mounting holes 50 of the diode support 12 from below. The terminal wires 60 of the diodes 14 and the corresponding terminal blocks of the diode support 12 are soldered or welded together.

In step S3, the resistor 16 is mounted to the case 4. The resistor 16 is inserted into the hole of the output tower 26 of the case 4. Step S3 may be performed before steps S1 and S2. These three steps may be carried out concurrently.

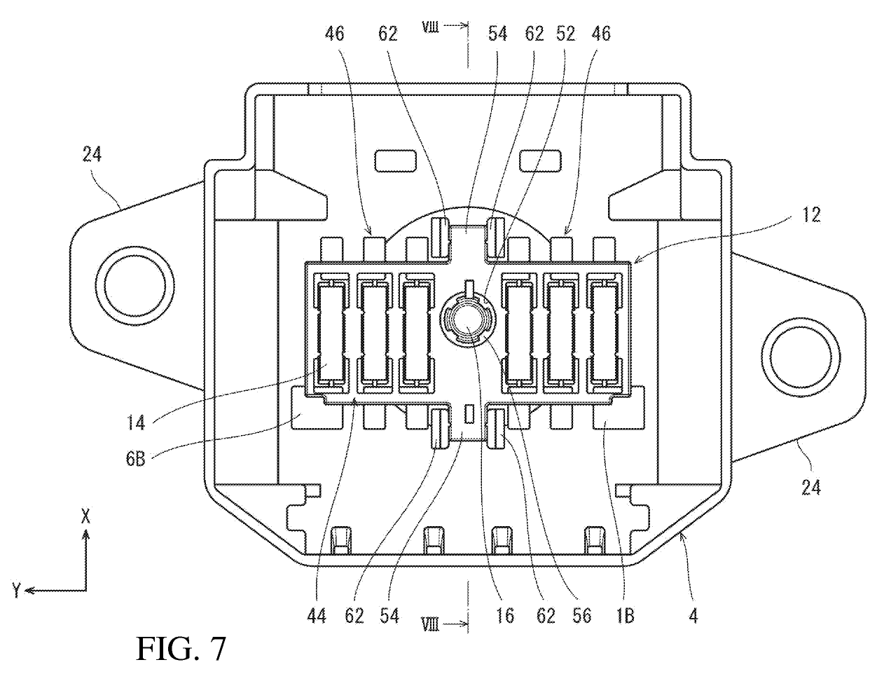

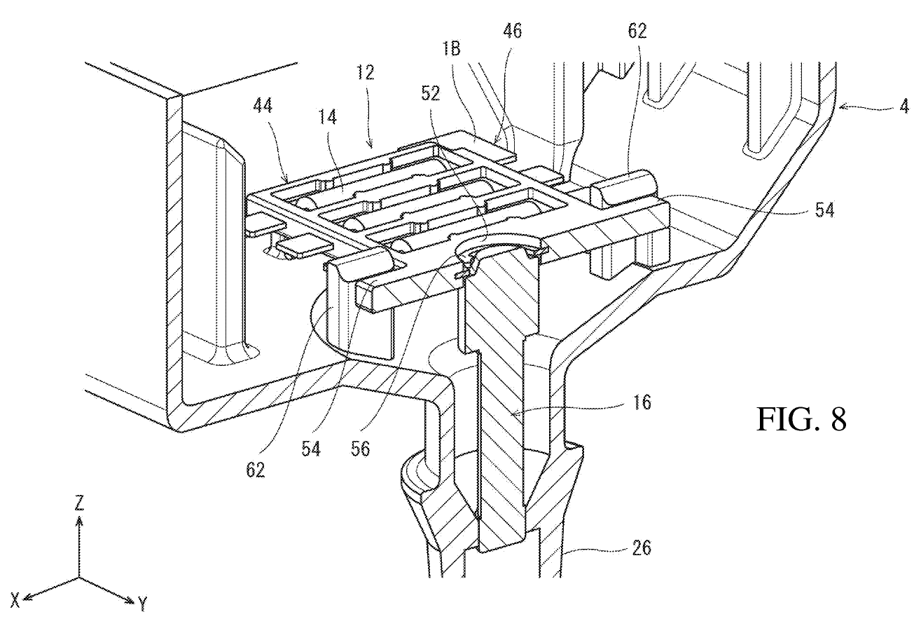

In step S4, as shown in FIG. 2, the diode support 12 is placed into the case 4 through the opening 20 of the case 4 and mounted to the bottom of the case 4. FIG. 7 is a plan view showing the diode support 12 mounted on the bottom of the case 4, and FIG. 8 is a perspective view of a cross-section taken along the line VIII-VIII of FIG. 7. As shown in FIGS. 7 and 8, the upper end of the resistor 16 is inserted into the outlet hole 52 of the frame 44, and the resistor 16 comes into contact with the outlet projecting portion 56 of the terminal pattern 46. In this embodiment, fixing pillars 62 are located on the bottom of the case 4, and each of the positioning protrusions 54 of the diode support 12 is fitted between two corresponding fixing pillars 62. Thus, the diode support 12 is precisely positioned on the inner bottom surface of the case 4.

In step S5, as shown in FIG. 2, the connector portion 6 is mounted to the case 4. The igniters 10 are mounted to the connector portion 6 beforehand. The connector portion 6 is mounted to the case 4 such that the igniters 10 are located within the case 4 and the base portion 40 of the connector portion 6 covers the front portion of the opening 20 of the case 4.

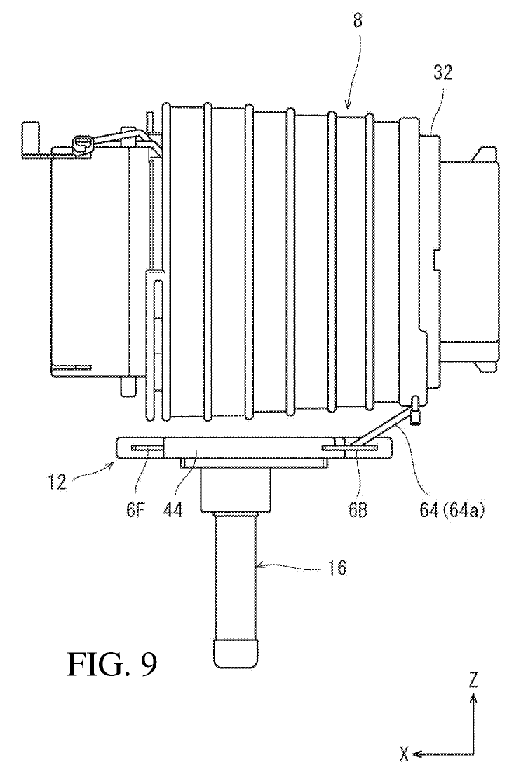

In step S6, as shown in FIG. 2, the coil assembly 8 is placed into the case 4 through the opening 20 of the case 4. FIG. 9 is a side view showing the coil assembly 8, the diode support 12, and the resistor 16, with the coil assembly 8 enclosed within the case 4. The coil assembly 8 is supported by an unshown support of the case 4, which ensures a predetermined distance between the coil assembly 8 and the diode support 12.

As shown in FIG. 9, leads 64 extending from the coil output terminals of the coil assembly 8 are attached to the coil assembly 8. Specifically, a first lead extending from the first coil output terminal of the first coil set 30 and a second lead 64a extending from the second coil output terminal of the second coil set 32 are attached to the coil assembly 8. When the coil assembly 8 is enclosed within the case 4, the first lead contacts the inlet terminal block 1B, and the second lead 64a contacts the inlet terminal block 6B. FIG. 9 shows the second lead 64a in contact with the inlet terminal block 6B.

In step S7, a fluid filling material is poured into the case 4. The fluid filling material fills gaps present in the case 4. The filling material is then hardened. In this embodiment, the hardening of the filling material is accomplished by heating. As a result, the filling material turns into the filler 18. This completes the assembly of the ignition coil 2.

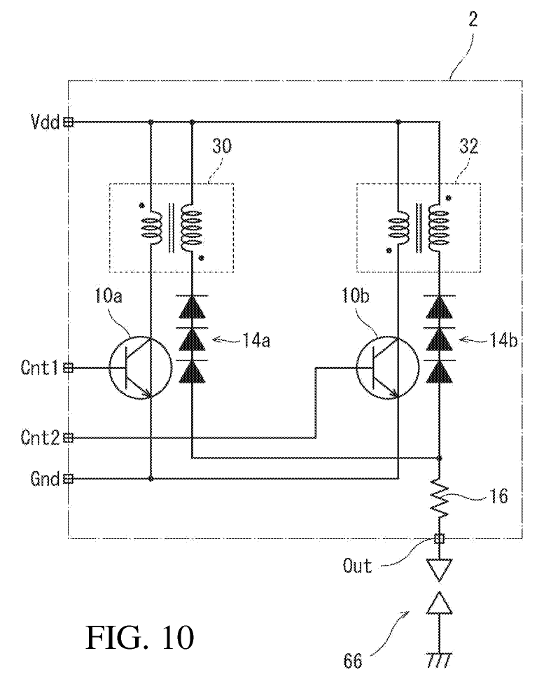

FIG. 10 shows a circuit diagram of the ignition coil 2 of FIG. 1. This figure further includes a circuit diagram of an ignition plug 66. The circuit diagram includes the first coil set 30, the first igniter 10a, the first diode set 14a, the second coil set 32, the second igniter 10b, and the second diode set 14b as components of the ignition coil 2. The circuit diagram further includes a first control terminal Cnt1, a second control terminal Cnt2, an output terminal Out, a power supply terminal Vdd, and a ground terminal Gnd as external terminals of the ignition coil 2. In this embodiment, as described above, the first control terminal Cnt1, the second control terminal Cnt2, the power supply terminal Vdd, and the ground terminal Gnd correspond to the connector terminals 42. As described above, the lower end of the resistor 16 serves as the output terminal Out.

The first control terminal Cnt1 is connected to the first igniter 10a. In response to a signal from the first control terminal Cnt1, the first igniter 10a switches between permitting (ON) and blocking (OFF) current flow through the primary coil of the first coil set 30. When current flow through the primary coil of the first coil set 30 switches from ON to OFF, a high voltage is generated in the secondary coil 34 of the first coil set 30. The terminal for outputs from the secondary coil 34 (the first coil output terminal of the first coil set 30) is connected to the first diode set 14a, and the first diode set 14a is connected to the resistor 16. These connections are established via the leads 64 and the diode support 12. As described above, the first diode set 14a is forward-biased with respect to the high voltage applied from the first coil set 30. Thus, the high voltage passes through the first diode set 14a into the resistor 16. The high voltage from the first coil set 30 is output from the output terminal Out and input to the ignition plug 66.

The second control terminal Cnt2 is connected to the second igniter 10b. In response to a signal from the second control terminal Cnt2, the second igniter 10b switches between ON and OFF of current flow through the primary coil of the second coil set 32. When current flow through the primary coil of the second coil set 32 switches from ON to OFF, a high voltage is generated in the secondary coil 34 of the second coil set 32. The terminal for outputs from the secondary coil 34 (the second coil output terminal of the second coil set 32) is connected to the second diode set 14b, and the second diode set 14b is connected to the resistor 16. These connections are established via the leads 64 and the diode support 12. As described above, the second diode set 14b is forward-biased with respect to the high voltage applied from the second coil set 32. Thus, the high voltage passes through the second diode set 14b into the resistor 16. The high voltage from the second coil set 32 is output from the output terminal Out and input to the ignition plug 66.

As shown in FIG. 10, the output of the first coil set 30 and the output of the second coil set 32 are short-circuited between the first and second diode sets 14a and 14b and the resistor 16. When a high voltage is output from the first coil set 30 in the absence of high voltage output from the second coil set 32, the second diode set 14b is reverse-biased with respect to the high voltage applied from the first coil set 30. The second diode set 14b prevents the output current from the first coil set 30 from flowing into the second coil set 32. Likewise, when a high voltage is output from the second coil set 32 in the absence of high voltage output from the first coil set 30, the first diode set 14a is reverse-biased with respect to the high voltage applied from the second coil set 32. The first diode set 14a prevents the output current from the second coil set 32 from flowing into the first coil set 30.

The following describes the workings and effects of the present embodiment.

In the ignition coil 2 of the present embodiment, the arrangement of the diodes 14 and the connection of the diodes 14 with the coil assembly 8 can be achieved simply by mounting the diode support 12 with the diodes 14 to the bottom of the case 4 and placing the coil assembly 8 into the case 4. This ignition coil 2 can be assembled efficiently.

In the present embodiment, a predetermined distance is maintained between the coil assembly 8 and the diode support 12 in the case 4. An insulating distance between the diodes 14 and the coil assembly 8 can be ensured with high precision simply by placing the diode support 12 with the diodes 14 and the coil assembly 8 into the case 4. In this ignition coil 2, the required insulating distance can be achieved efficiently and with high precision.

In the present embodiment, the diode support 12 has the shape of a flat plate. Such a diode support 12 is easily mountable to the bottoms of cases 4 of varying sizes. The connection of the diodes 14 with coil assemblies 8 of varying sizes can be established, for example, simply by adjusting the lengths of the leads 64. This ignition coil 2 can be assembled efficiently.

In the present embodiment, the terminal wires 60 of the diodes 14 are in contact with the surface of the terminal pattern 46 that faces away from the coil assembly 8. Accordingly, even when the portions where the terminal wires 60 and the terminal pattern 46 are soldered or welded together have increased heights, these increased heights do not affect the distance between the wires connected to the diode 14 and the coil assembly 8. The insulating distance between the diodes 14 and the coil assembly 8 can be maintained irrespective of the heights of the soldered or welded portions.

In the present embodiment, the diode support 12 includes the outlet hole 52, and the resistor 16 and the terminal pattern 46 are brought into contact by inserting the upper end of the resistor 16 into the outlet hole 52. By inserting the upper end of the resistor 16 into the outlet hole 52, the first and second diode sets 14a and 14b can be connected to the resistor 16. This ignition coil 2 can be assembled efficiently.

In the embodiment described above, the coil assembly 8 is a dual coil. The coil assembly need not be a dual coil. The coil assembly may include a single coil set. In this case, the ignition coil includes a single control terminal, a single igniter, and a single diode set.

As described above, the present embodiment can provide an ignition coil that exhibits high ignition performance and that has a reduced size. This demonstrates the superiority of the present embodiment.

### Disclosed Items

The following items disclose preferred embodiments.

### Item 1

An ignition coil including:
a coil assembly including a primary coil and a secondary coil;
   a case enclosing the coil assembly;
   a diode support having a shape of a flat plate, the diode support being located below the coil assembly and mounted on a bottom of the case;
   one or more diodes fixed to the diode support; and
   an output terminal, wherein
   an output from the coil assembly is output to the output terminal through the diodes.

### Item 2

The ignition coil according to item 1, wherein
the diode support includes:
an electrically insulating frame including mounting portions to which the diodes are mounted; and
an electrically conductive terminal pattern that is fixed to the frame and that ensures an electrical connection among the coil assembly, the diodes, and the output terminal, and
terminals of the diodes are in contact with a surface of the terminal pattern that faces away from the coil assembly.

### Item 3

The ignition coil according to item 2, further including a resistor, wherein
the diode support includes a hole,
the resistor includes an upper end inserted in the hole and is in contact with the terminal pattern at the upper end, and
the diodes are electrically connected to the output terminal via the resistor in contact with the terminal pattern.

### Item 4

The ignition coil according to any one of items 1 to 3, including one or more first diodes and one or more second diodes that are fixed to the diode support, wherein
the coil assembly includes a first coil set and a second coil set,
an output from the first coil set is output to the output terminal through the first diodes, and
an output from the second coil set is output to the output terminal through the second diodes.

### Item 5

A method of producing an ignition coil, including the steps of:
(A) fixing one or more diodes to a diode support having a shape of a flat plate;
(B) mounting the diode support with the fixed diodes to a bottom of a case; and
(C) placing a coil assembly into the case.

### Item 6

The method according to item 5, further including the step of mounting a resistor to the case before the step (B), wherein
the step (B) includes inserting the resistor into a hole of the diode support to electrically connect the diodes to the resistor.

### Item 7

The method according to item 5 or 6, wherein
the step (A) includes soldering or welding terminals of the diodes to a first surface of the diode support, and
the step (B) includes mounting the diode support to the bottom of the case such that the first surface faces the bottom of the case and that a second surface of the diode support opposite to the first surface faces the coil assembly.

### Item 8

The method according to any one of items 5 to 7, wherein
the diode support includes a frame made of a resin composition and an electrically conductive terminal pattern integrated with the frame, and
the method further includes the step of forming the diode support by injection molding before the step (A).

The foregoing description is given for illustrative purposes, and various modifications can be made without departing from the principles of the present invention.

What is claimed is:

1. An ignition coil comprising:
a coil assembly including a primary coil and a secondary coil;
a case enclosing the coil assembly;
a diode support having a shape of a flat plate, the diode support being located below the coil assembly and mounted on a bottom of the case;
one or more diodes fixed to the diode support; and
an output terminal, wherein
an output from the coil assembly is output to the output terminal through the diodes.

2. The ignition coil according to claim 1, wherein
the diode support includes:
an electrically insulating frame including mounting portions to which the diodes are mounted; and
an electrically conductive terminal pattern that is fixed to the frame and that ensures an electrical connection among the coil assembly, the diodes, and the output terminal, and
terminals of the diodes are in contact with a surface of the terminal pattern that faces away from the coil assembly.

3. The ignition coil according to claim 2, further comprising a resistor, wherein
the diode support includes a hole,
the resistor includes an upper end inserted in the hole and is in contact with the terminal pattern at the upper end, and
the diodes are electrically connected to the output terminal via the resistor in contact with the terminal pattern.

4. The ignition coil according to claim 1, comprising one or more first diodes and one or more second diodes that are fixed to the diode support, wherein
the coil assembly includes a first coil set and a second coil set,
an output from the first coil set is output to the output terminal through the first diodes, and
an output from the second coil set is output to the output terminal through the second diodes.

5. A method of producing an ignition coil, comprising the steps of:
(A) fixing one or more diodes to a diode support having a shape of a flat plate;
(B) mounting the diode support with the fixed diodes to a bottom of a case; and
(C) placing a coil assembly into the case.

6. The method according to claim 5, further comprising the step of mounting a resistor to the case before the step (B), wherein
the step (B) includes inserting the resistor into a hole of the diode support to electrically connect the diodes to the resistor.

7. The method according to claim 5, wherein
the step (A) includes soldering or welding terminals of the diodes to a first surface of the diode support, and
the step (B) includes mounting the diode support to the bottom of the case such that the first surface faces the bottom of the case and that a second surface of the diode support opposite to the first surface faces the coil assembly.

8. The method according to claim 5, wherein
the diode support includes a frame made of a resin composition and an electrically conductive terminal pattern integrated with the frame, and
the method further comprises the step of forming the diode support by injection molding before the step (A).
